(19) United States
(12) Patent Application Publication
(10) Pub. No.: US 2018/0189217 A1
(43) Pub. Date: Jul. 5, 2018

(54) TECHNIQUES FOR AN EXTENDABLE PERIPHERAL PORT

(71) Applicant: INTEL CORPORATION, Santa Clara, CA (US)

(72) Inventors: PUJITHA DAVULURI, PORTLAND, OR (US); CHUNG-HAO J. CHEN, PORTLAND, OR (US); BOON PING KOH, SEBERANG JAYA (MY)

(21) Appl. No.: 15/394,530

(22) Filed: Dec. 29, 2016

(51) Int. Cl. G06F 13/40; G06F 13/42; G06F 13/38

(52) U.S. Cl. CPC G06F 13/4068; G06F 13/385; G06F 13/4282

(57) ABSTRACT

Various embodiments may be generally directed to techniques for an extendable peripheral port. Some embodiments are particularly directed to a computing device, such as an input/output (I/O) device, with a peripheral port that can be selectively repositioned to increase the distance between the peripheral port and one or more components of the I/O device that are sensitive to radio frequency interference (RFI), such as an antenna.

### BACKGROUND

Generally, a peripheral may include any auxiliary device that interfaces with a computing device in some way. In computing, interfacing may refer to communicating information or power between separate components of a computer system, such as a computing device and a peripheral, across a shared boundary. Typically, when the interface between the computing device and the peripheral includes a physical connection, the interface may be referred to as a hardware interface. A hardware interface, may include an electrical connection point where electrical terminations between the computing device are joined at the shared boundary. The electrical connection point may include a first part that is rigidly mounted to the computing device, such as a female-ended jack, and a second part that connects or is attached to the peripheral, such as a male-ended plug. The first part of the electrical connection point may be referred to as a port and can be female-ended or male-ended. When the first and second parts are connected together, or mated, a connection may be established between the computing device and the peripheral that can be used for the communication of information or power.

### BRIEF DESCRIPTION OF THE DRAWINGS

FIGS. 1A-1B illustrate embodiments of a computer system.

FIG. 2 illustrates a block diagram of an embodiment of an input/output (I/O) device.

FIG. 3A illustrates an embodiment of a retracted state for an exemplary peripheral port of an I/O device.

FIG. 3B illustrates an embodiment of an extended state for an exemplary peripheral port of an I/O device.

FIG. 4 illustrates an embodiment of throughput performance for an exemplary I/O device.

FIG. 5 illustrates an embodiment of a storage medium.

FIG. 6 illustrates an embodiment of a computing architecture.

FIG. 7 illustrates an embodiment of a communications architecture.

### DETAILED DESCRIPTION

Various embodiments may be generally directed to techniques for an extendable peripheral port. Some embodiments are particularly directed to a computing device, such as an input/output (I/O) device, with a peripheral port that can be selectively repositioned to increase the distance between the peripheral port and one or more components of the I/O device that are sensitive to radio frequency interference (RFI), such as an antenna. In one embodiment, for example, an apparatus may comprise a processor component communicatively coupled with an antenna via a first set of conductive connections and a peripheral port coupled to the processor component via a second set of conductive connections. A peripheral port extender including one or more conductive connections of the second set of conductive connections is provided to reversibly transition the peripheral port between a retracted state and an extended state. In particular, a distance between the peripheral port and the antenna can increase in response to a transition from the retracted state to the extended state. This and other embodiments are described and claimed.

Some challenges facing I/O devices include excessively complex, bulky, impractical, and inefficient techniques for preventing RFI from affecting the performance of I/O operations. These challenges may result from one or more communication pathways of an I/O device affecting the performance of other communication pathways of the I/O device, such as a wired communication pathway generating radiation that causes noise in a wireless communication pathway. For example, radiation generated by one or more connection points in a wired communication pathway may cause noise that couples with an antenna and interferes with the ability of an associated radio to recover communication signals received by an antenna. This interference may include radio frequency interference (RFI), and may result in a degradation of data throughput and reduction in wireless range. Adding further to the complexity, the proximity of a connection point to an antenna can be a primary factor in the impact of RFI, and many I/O devices have a small form factor. Requiring a small form factor forces antennae and connection points to be in close proximity. These factors may result in I/O devices with poor performance and limited applications. Such limitations can drastically reduce the usability and applicability of such I/O devices, contributing to inefficient devices with reduced capabilities.

Various embodiments described herein include an I/O device with one or more peripheral port extenders to decrease interference between different communication pathways. A peripheral port extender may enable a connection point in a wired communication pathway to be temporarily relocated away from an antenna, thereby protecting one or more wireless communication pathways from RFI. For example, the peripheral port extender may include an extendable cable assembly that connects the I/O device to the peripheral port and enables the peripheral port to be repositioned with respect to one or more antennae of the I/O device. In these and other ways the peripheral port extender may enable robust and efficient I/O operations to achieve better performing and more dynamic I/O devices, resulting in several technical effects and advantages.

With general reference to notations and nomenclature used herein, portion of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatuses may be specially constructed for the required purpose or may include a general-purpose computer. The required structure for a variety of these machines will be apparent from the description given.

Reference is now made to the drawings, wherein like reference numerals are used to refer to like elements throughout. In the following description, for purpose of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modification, equivalents, and alternatives within the scope of the claims.

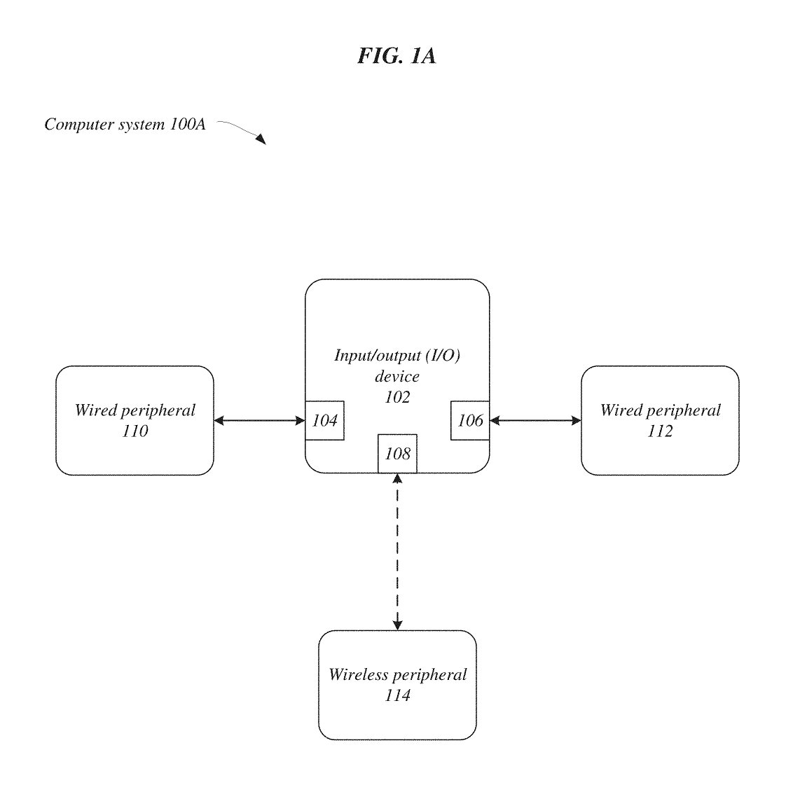

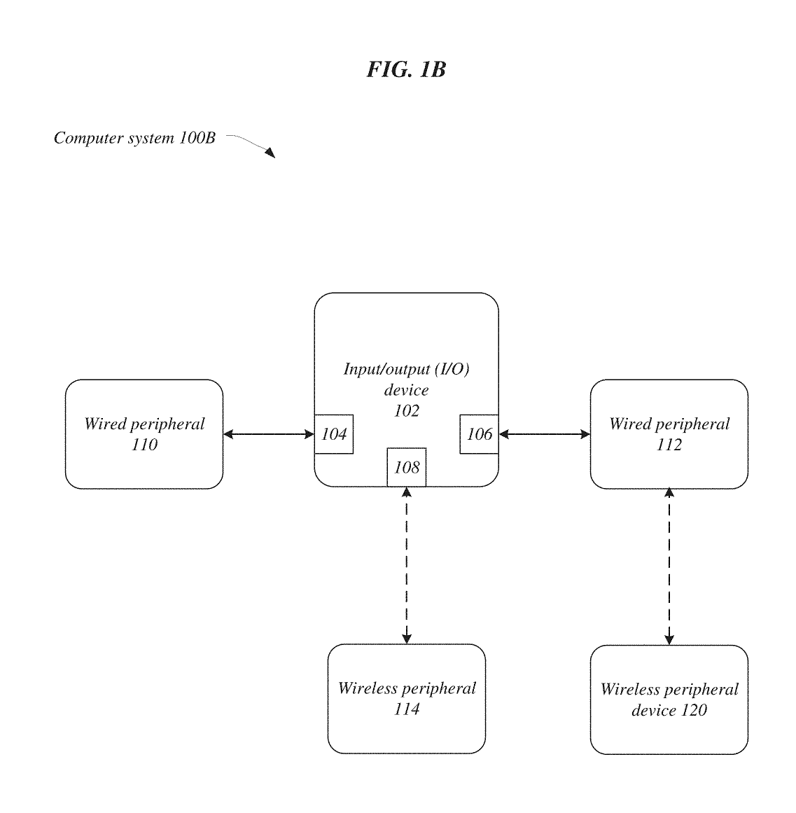

FIGS. 1A-1B illustrate embodiments a computer system. Computer systems 100A, 100B may include an input/output (I/O) device 102 that is able to communicatively couple with one or more peripherals to establish one or more communication pathways. For example, in computer systems 100A, 100B, I/O device 102 may include port 104, port 106, and antenna 108. Port 104 may enable a wired communication pathway to be established between wired peripheral 110 and I/O device 102; port 106 may enable a wired communication pathway to be established between wired peripheral 112 and I/O device 102; and antenna 108 may enable a wireless communication pathway to be established between wireless peripheral 114 and I/O device 102. Additionally, computer system 100B may include wireless peripheral 120 with a wireless communication pathway connecting to wired peripheral 112. In some embodiments, these communication pathways may enable one or more components of computer systems 100A, 100B to communicate one or more of power and information among each other. In various embodiments described herein, one or more ports of I/O device 102 (e.g., ports 104 and 106) may be repositioned to increase a distance between the port and one or more antennae (e.g., antenna 108). Increasing the distance between a port and an antenna may improve communication involving one or more of I/O device 102, wired peripherals 110, 112, and wireless peripherals 114, 120 in various embodiments described herein. Embodiments are not limited in this context.

In various embodiments, port 104 may serve as a connection point to communicatively couple wired peripheral 110 and I/O device 102 and port 106 may serve as a connection point to communicatively couple wired peripheral 112 and I/O device 102. In various embodiments, peripherals 110, 112, 114 may include one or more components that can interface with I/O device 102, such as a display, a keyboard, a mouse, a wireless mouse dongle, an external hard drive, a flash drive, a controller, a speaker, a power source, a hotspot, or the like. In the illustrated embodiments, I/O device 102 includes two ports and one antenna, however in other embodiments, I/O device 102 may include any number and/or combinations of ports and antennae. Further, I/O device 102 may include any combination of types of ports, such as one or more of a digital visual interface (DVI), a display port (DP), a serial port, a video graphics array (VGA) port, a high-definition multimedia interface (HDMI) port, a universal serial bus (USB) port, a thunderbolt port, and the like. In some embodiments, these connection points may be a source of noise that affects communication between one or more components of computer systems 100A, 100B, such as between wireless peripheral 114 and I/O device 102 by coupling with antenna 108. For instance, noise may couple from the backside of port directly to antenna 108.

In some embodiments, one or more peripherals may be a source of noise that affects communication between wireless peripheral 114 and I/O device 102. For example, in computing system 100B, wired peripheral 112 may be a transceiver for wireless peripheral 120, which may be a wireless mouse. In such examples, the wireless signals exchanged between wired peripheral 112 and wireless peripheral 120 may interfere with communication between wireless peripheral 114 and I/O device 102. Thus wired peripheral 112 and/or wireless peripheral 120 may be sources of noise, such as by emitting signals that coupled with antenna 108. On the other hand, wireless signals exchanged between I/O device 102 and wireless peripheral 114 may interfere with communication between wired peripheral 112 and wireless peripheral 120, thus I/O device 102 and/or wireless peripheral 114 may be sources of noise. In some embodiments, relocating one or more of ports 104, 106 may reduce the effects of sources of noise, thereby improving communication between one or more components of computer systems 100A, 100B.

In various embodiments, when I/O device 102 is communicatively coupled with a peripheral (e.g., peripherals 110, 112, or 114) a communication pathway is established. These communication pathways may be used to communicate information and/or power between the coupled devices. For example, wired peripheral 112 may be a charger and I/O device 102 may receive power from the charger over a wired communication pathway established via port 106. In another example, wired peripheral may be an external hard drive and I/O device 102 may store and retrieve information on the external hard drive over a wired communication pathway established via port 106. In some embodiments, one or more communication pathways may be used for signaling, such as differential signaling or single-ended signaling. In various embodiments, when a communication pathway has the potential to interfere with another, one or more components of the communication pathway (e.g., port 104, port 106), may be repositioned to reduce the potential of the communication pathway to interfere with the other.

In some embodiments, I/O device 102 may receive data as input from one or more communicatively coupled peripherals 110, 112, 114, or wireless peripheral 120 via wired peripheral 112. In various embodiments, I/O device 102 may output data to one or more communicatively coupled peripherals 110, 112, 114, or wireless peripheral 120 via wired peripheral. In various such embodiments, the output data may be based on the input received from one or more of peripherals 110, 112, 114, or wireless peripheral 120 via wired peripheral 112. For example, I/O device 102 may include a personal computer (PC) stick, wired peripheral device 112 may include a mouse that connects to port 106 with a male connector, wired peripheral device 110 may include a monitor that connects to port 104 with a female connector, and wireless peripheral device 114 may include a wireless access point (AP) that communications with I/O device 102 via antenna 108. In such examples, the PC stick may cause a graphical user interface (GUI) to be displayed on the monitor, the mouse may provide input by selecting an item on the GUI, and, in response to selection of the item, the PC stick may retrieve information from the internet via the wireless AP. In various embodiments described herein, increasing the distance between antenna 108 and one or more of ports 104, 106 may improve throughput of one or more wireless communication pathways of computer systems 100A, 100B. Thus, in the above example, the PC stick may be able to retrieve information from the internet quicker.

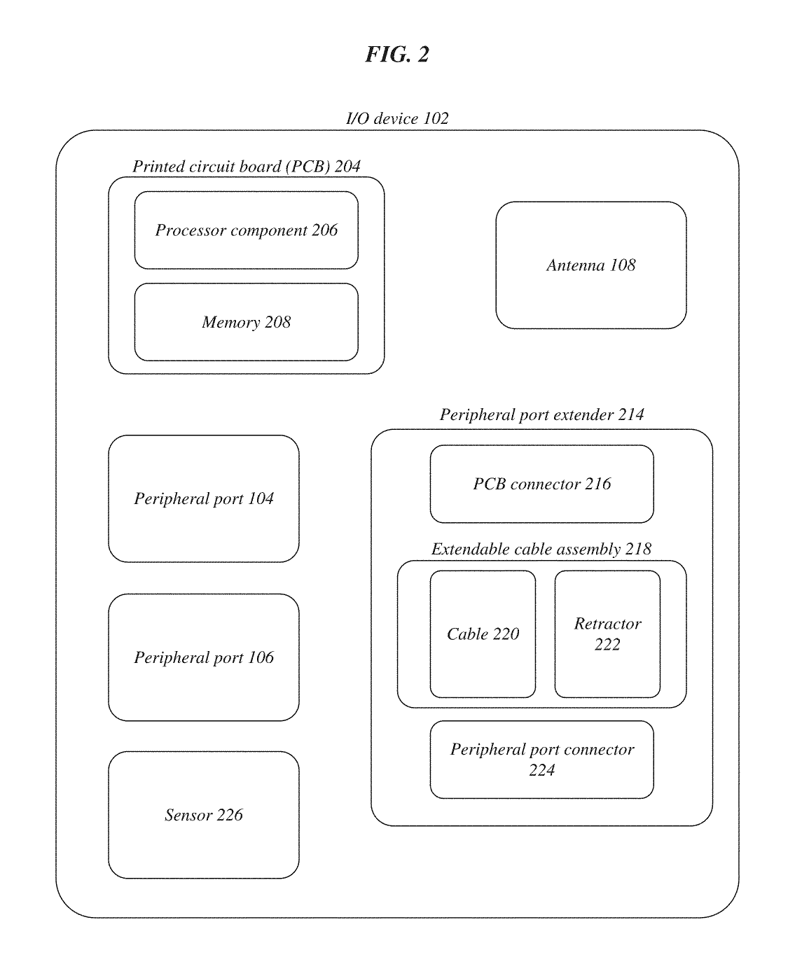

FIG. 2 illustrates a block diagram of an embodiment of I/O device 102. I/O device 102 may include printed circuit board (PCB) 204, processor component 206, memory 208, peripheral port 104, peripheral port 106, antenna 108, and peripheral port extender 214. In various embodiments, I/O device 102 may include one or more port extenders that enable one or more peripheral ports to be repositioned, such as away from one or more antennae. For example, I/O device 102 may include processor component 206 communicatively coupled to antenna 108 via a first set of conductive connections and peripheral port 106 via a second set of conductive connections. I/O device 102 may also include peripheral port extender 214 including one or more conductive connections of the second set of conductive connections, the peripheral port extender 214 able to reversibly transition peripheral port 106 between a retracted state and an extended state, a distance between the peripheral port 106 and the antenna 108 to increase when the peripheral port extender is transitioned from the retracted state to the extended state. Embodiments not limited in this context.

In the various embodiments, PCB 204 may electrically connect to processor component 206 and memory 208. In some embodiments, PCB 204 may communicatively couple processor component 206 and memory 208 with a set of conductive connections, such as via one or more conductive traces, for instance. In various embodiments, a wired communication pathway may be created between I/O device 102 and a peripheral (e.g., wired peripheral 112) when an unbroken chain of conductive connections (i.e. a circuit) is established between I/O device 102 and the peripheral. In one or more embodiments described herein, peripheral port 104 may provide the final conductive connection needed to complete the circuit and establish the wired communication pathway. In some embodiments, one or more of the conductive connections described herein may include shielding from RFI or from producing RF emissions, such as grounding and the like. In some such embodiments, the shielding may prevent RF emissions from the shielded conductive connections interfering with other components or RFI from other sources interfering with the one or more conductive connections. In various embodiments, memory 208 may store instructions that when executed by processor component 206 may cause I/O device 102 to realize one or more embodiments described herein. In some embodiments, PCB 204 may include one or more conductive traces that communicatively couple peripheral port 104 with processor component 206. In various embodiments, PCB 204 may include one or more conductive traces may enable process circuit 206 to communicatively couple with peripheral port 106 via peripheral port extender 214.

In some embodiments, each peripheral port extender 214 may include PCB connector 216, an extendable cable assembly 218, and peripheral port connector 224. PCB connector 216 may communicatively couple peripheral port extender 214 to processor component 206 via conductive connections, such as one or more conductive traces of PCB 204. Peripheral port connector 224 may communicatively couple peripheral port extender 214 to peripheral port 106 via one or more conductive connections. In various embodiments, one or more of the connections made by PCB connector 216 and peripheral port connector 224 may utilize welding, solders, crimping, and the like. Extendable cable assembly 218 may enable peripheral port 106 to be repositioned with respect to antenna 108. For example, when a peripheral connects to I/O device 102 via peripheral port 106, by positioning the connection point (i.e., peripheral port 106) further away from antenna 108, antenna 108 may pick up less noise, resulting in reduced RFI.

In various embodiments, extendable cable assembly 218 may include one or more components to enable peripheral port 106 to be selectively repositioned. In the illustrated embodiment, extendable cable assembly 218 may include cable 220 and retractor 222. Cable 220 may include one or more electrically isolated conductors. In various embodiments, cable 220 may include shielding from RFI generated by other sources or shielding from RF emissions produced by cable 220. For instance, the shielding may prevent cable 220 from emitting RF signals or from RF produced by other components interference with cable 220. In some embodiments PCB 204 may include separate conductive traces for each electrically isolated conductor of cable 220. In various embodiments, cable 220 may be able to be extended or retracted from I/O device 102, thereby enabling peripheral port 106 to be selectable relocated. In some embodiments, retractor 222 may store portions of cable 220 that are not extending from I/O device 102. In some such embodiments, one or more portions of cable 220 may be coiled around retractor 222 when stored.

In some embodiments, retractor 222 may transition peripheral port 106 between a retracted state and one or more extended states. In some such embodiments, the distance between peripheral port 106 and antenna 108 may increase by a different amount when the peripheral port 106 is transitioned from the retracted state to each of the one or more extended states. In various embodiments, retractor 222 may include one or more components to transition peripheral port 106 between states or assist a user in transitioning peripheral port 106 between states. In various such embodiments, retractor 222 may store an amount of potential kinetic energy that increases when the peripheral port 106 is transitioned from the retracted state to the extended state and decreases when the peripheral port 106 is transitioned from the extended state to the retracted state. For example, retractor 222 may include a spring that provides resistance when the peripheral port 106 transitions to the extended state and assistance when the peripheral port 106 transitions to the retracted state. In some embodiments, retractor 222 may include an electric motor to extend and/or retract cable 220 to assist with transitioning peripheral port 106 between different states.

In various embodiments, I/O device 102 may include one or more sensors (e.g., sensor 226) to detect, measure, or estimate one or more of the state of peripheral port 214, the position of peripheral port 106, the status of one or more components of peripheral port extender 214, a distance between antenna 108 and peripheral port 106, the interference antenna 108 receives from peripheral port 106, and one or more features or operational parameters of I/O device 102 and various peripherals. In some embodiments memory 208 may store one or more instructions that when executed by processor component 206 implement one or more algorithms to perform one or more optimizations. For instance, I/O device 102 may recommend or implement one or more positions or states for peripheral port 106.

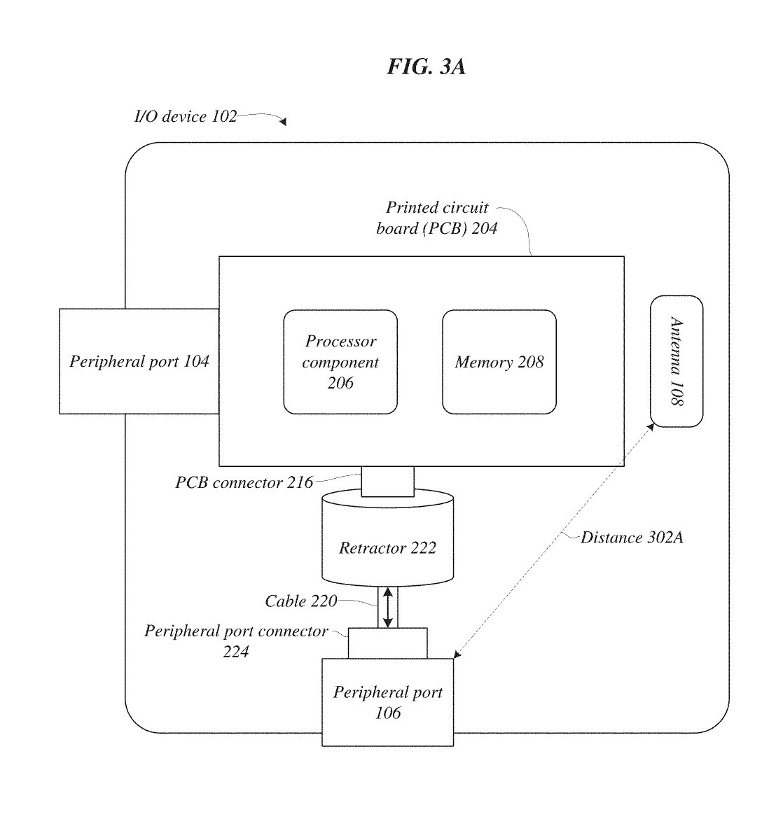

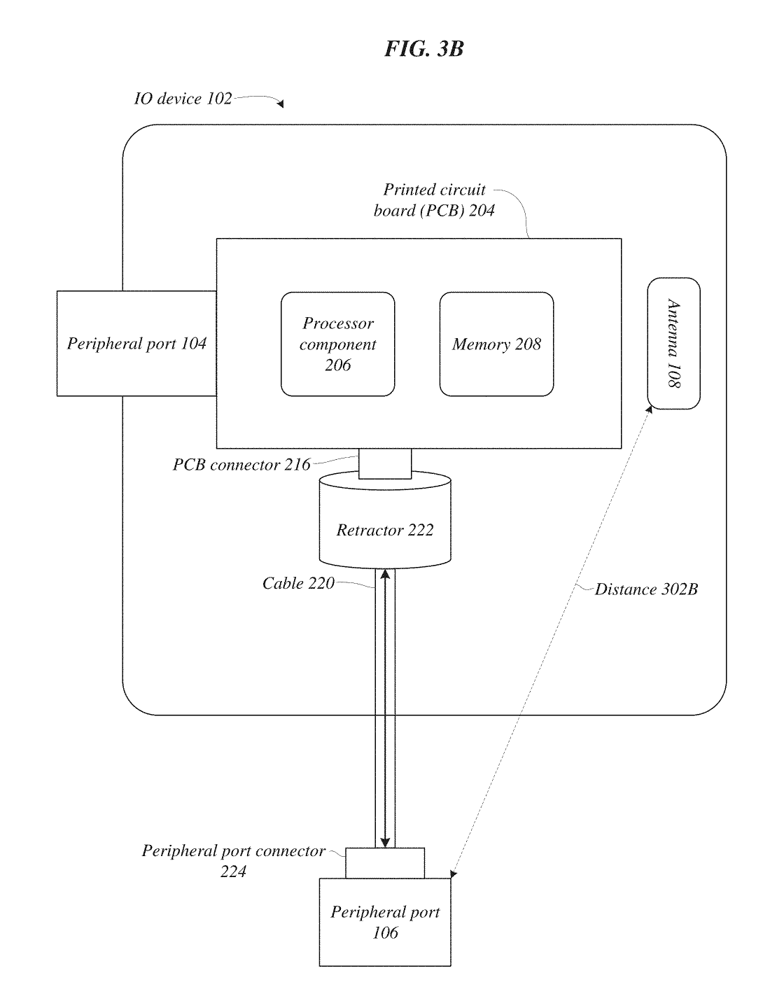

FIG. 3A illustrates an embodiment of a retracted state for peripheral port 106 of I/O device 102. In the retracted state, peripheral port 106 may be located distance 302A from antenna 108. In some embodiments, at distance 302A, peripheral port 106 may cause noise that interferes with antenna 108. In some such embodiments, the noise may degrade the performance of I/O device 102. In various embodiments, the noise may be caused by one or more peripherals (e.g., wired peripheral 112 or wireless peripheral 120) communicating with I/O device 102 via peripheral port 106. For instance, peripheral port 106 may connect with a wireless mouse dongle and communication between processor component 206 and the wireless mouse dongle may cause antenna 108 to experience noise because peripheral port 106 is so proximate to antenna 108 at distance 302A. Further, communication between the wireless mouse dongle and the associated wireless mouse may cause antenna 108 to experience noise because of the close proximity of the wireless mouse dongle to antenna 108. In another example, peripheral port 106 may connect with an external memory and communication between processor component 206 and the external memory may cause antenna 108 to experience noise because peripheral port 106 is so proximate to antenna 108 at distance 302A. Embodiments are not limited in this context.

In various embodiments, retractor 222 may house or store one or more portions of cable 220 when peripheral port 106 is in the retracted state. In some embodiments, one or more of peripheral port 106, PCB connector 216, cable 220, retractor 222, and peripheral port connector 224 may include shielding from RFI generated by external sources or shielding from RF emissions from the component. In some embodiments, the communication pathway between peripheral port 106 and processor component 206 may be blocked or severed when peripheral port 106 is in the retracted state. In some such embodiments, processor component 206 may cause the communication pathway to be severed in response to measurements of one or more sensors (e.g., sensor 226).

FIG. 3B illustrates an embodiment of an extended state for peripheral port 106 of I/O device 102. In the extended state, peripheral port 106 may be located distance 302B from antenna 108. In some embodiments, at distance 302B, peripheral port 106 may not cause noise or cause less noise that interferes with antenna 108 at distance 302A. In some such embodiments, the reduction in interference may improve the performance of I/O device 102. For instance, peripheral port 106 may connect with a wireless mouse dongle. In such instances, communication between processor component 206 and the wireless mouse dongle may not cause antenna 108 to experience noise because peripheral port 106 is less proximate to antenna 108 at distance 302B. Further, communication between the wireless mouse dongle and the associated wireless mouse may not cause antenna 108 to experience noise because the wireless mouse dongle is less proximate to antenna 108. Examples are not limited in this context.

In various embodiments, retractor 222 may house or store one or more portions of cable 220 when peripheral port 106 is in the extended state. In various such embodiments, retractor 222 may store less of cable 220 in the extended state than the retracted state. For example, retractor 222 may house and/or supply the extra wired communication pathway length (e.g., cable 220) that may be necessary to enable peripheral port 106 to transition between states. In some embodiments, one or more of peripheral port 106, PCB connector 216, cable 220, retractor 222, and peripheral port connector 224 may include shielding from RFI generated by other sources or shielding from RF emissions produced by the component. In various embodiments, the communication pathway between peripheral port 106 and processor component 206 may be reestablished when peripheral port 106 is transitioned to the extended state. In some embodiments, an amount of cable 220 that is extended from or stored by retractor 222 during a state transition may be controlled by processor component 206. In some such embodiments, the amount of cable 220 that is extended from or stored by retractor 222 during a state transition may be based on one or more measurements by sensors (e.g., sensor 226).

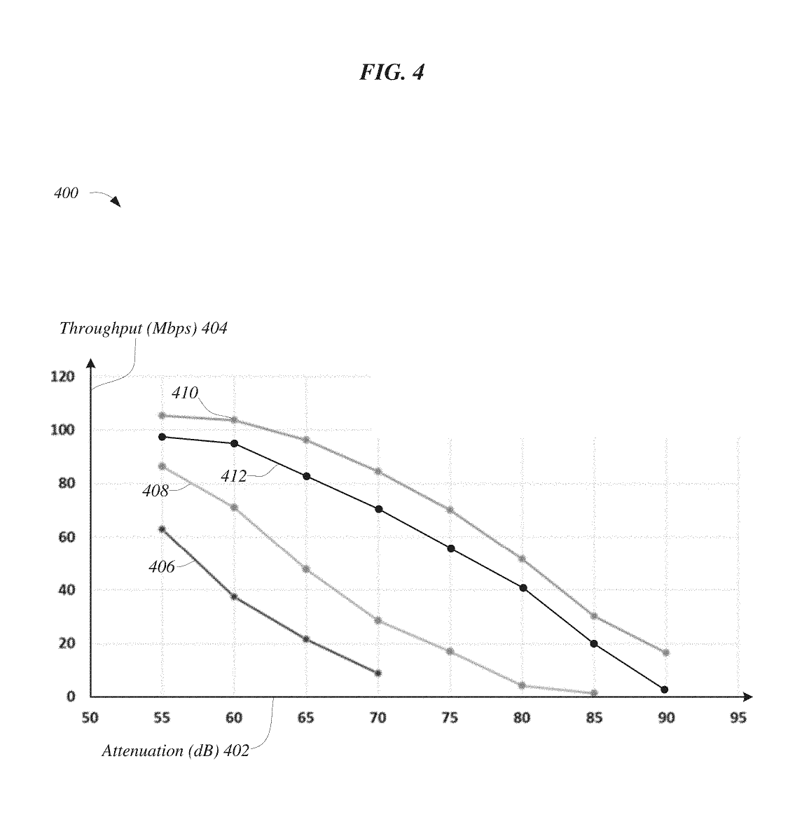

FIG. 4 illustrates an example of throughput performance in an exemplary embodiment of I/O device 104. Throughput in megabytes per second (Mbps) 404 of a wireless communication pathway may be represented on the vertical axis and attenuation in decibels (dB) 402 based on increasing length of the wireless communication pathway may be represented on the horizontal axis. In various embodiments, trend lines 406, 408, 410, 412 may each be associated with the performance of a communication pathway between an I/O device (e.g., I/O device 102) and a wireless peripheral (e.g., wireless peripheral 112) in different scenarios. For example, trend line 410 may be associated with no noise sources, trend line 406 may be associated with noise sources and no shielding from RFI, trend line 408 may be associated with noise sources and a peripheral port (e.g., peripheral port 106) that is shield from RFI or from producing RF emissions, and trend line 412 may be associated with one or more embodiments described herein in which peripheral port 106 is in an extended state. Embodiments are not limited in this context.

In various embodiments, trend line 410 may be associated with performance of a wireless communication channel when I/O device 102 is not connected to any wired peripherals. In some embodiments, trend line 412 may be associated with performance of a wireless communication channel when I/O device 102 is connected to one or more wired peripherals that cause noise that interferes with the wireless communication channel. The increase of throughput and less severe attenuation experienced by trend line 412 versus trend lines 408, 406 may demonstrate one or more improvements achieved by one or more embodiments described herein.

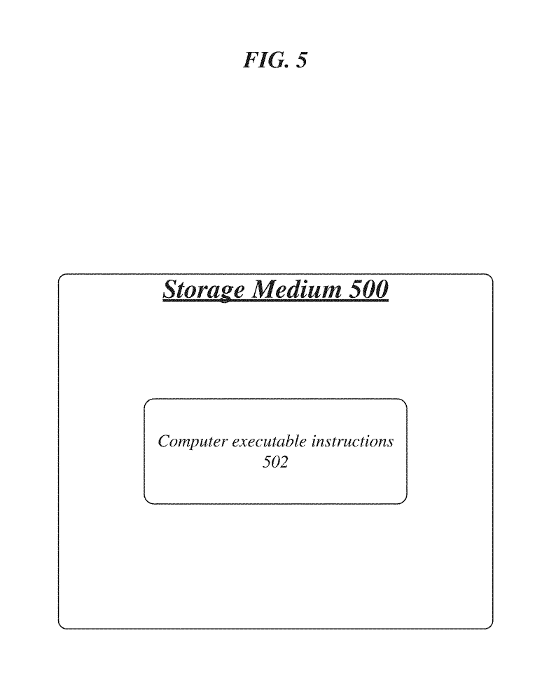

FIG. 5 illustrates an embodiment of a storage medium 500. Storage medium 500 may comprise any non-transitory computer-readable storage medium or machine-readable storage medium, such as an optical, magnetic or semiconductor storage medium. In various embodiments, storage medium 500 may comprise an article of manufacture. In some embodiments, storage medium 500 may store computer-executable instructions 502, such as computer-executable instructions to implement one or more of logic flows or operations described herein. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

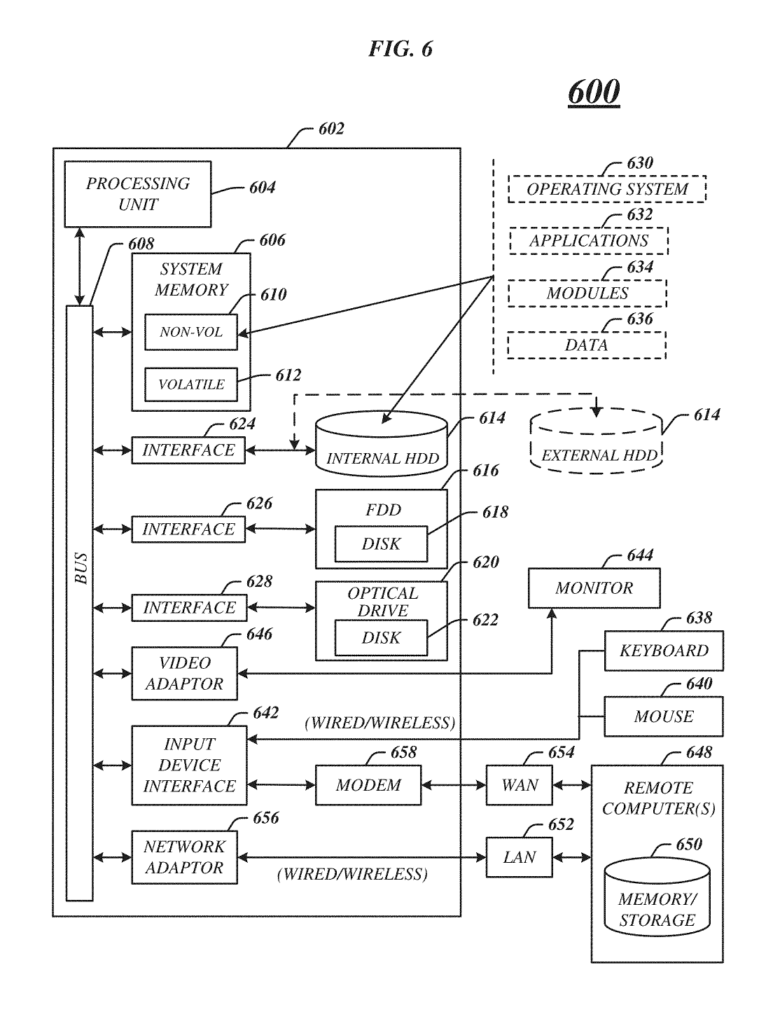

FIG. 6 illustrates an embodiment of an exemplary computing architecture 600 that may be suitable for implementing various embodiments as previously described. In various embodiments, the computing architecture 600 may comprise or be implemented as part of an electronic device. In some embodiments, the computing architecture 600 may be representative, for example, of a processor that implements one or more components of I/O device 102. In some embodiments, computing architecture 600 may be representative, for example, of a computer system that implements one or more components described herein. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 600. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 600 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 600.

As shown in FIG. 6, the computing architecture 600 comprises a processing unit 604, a system memory 606 and a system bus 608. The processing unit 604 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 604.

The system bus 608 provides an interface for system components including, but not limited to, the system memory 606 to the processing unit 604. The system bus 608 can be any of several types of bus structure that may further interconnect to a memory bus (with or without a memory controller), a peripheral bus, and a local bus using any of a variety of commercially available bus architectures. Interface adapters may connect to the system bus 608 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 606 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory (e.g., one or more flash arrays), polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 6, the system memory 606 can include non-volatile memory 610 and/or volatile memory 612. A basic input/output system (BIOS) can be stored in the non-volatile memory 610.

The computer 602 may include various types of computer-readable storage media in the form of one or more lower speed memory units, including an internal (or external) hard disk drive (HDD) 614, a magnetic floppy disk drive (FDD) 616 to read from or write to a removable magnetic disk 618, and an optical disk drive 620 to read from or write to a removable optical disk 622 (e.g., a CD-ROM or DVD). The HDD 614, FDD 616 and optical disk drive 620 can be connected to the system bus 608 by a HDD interface 624, an FDD interface 626 and an optical drive interface 628, respectively. The HDD interface 624 for external drive implementations can include at least one or both of Universal Serial Bus (USB) and IEEE 994 interface technologies.

The drives and associated computer-readable media provide volatile and/or nonvolatile storage of data, data structures, computer-executable instructions, and so forth. For example, a number of program modules can be stored in the drives and memory units 610, 612, including an operating system 630, one or more application programs 632, other program modules 634, and program data 636. In one embodiment, the one or more application programs 632, other program modules 634, and program data 636 can include, for example, the various applications and/or components of computer systems 100A, 100B.

A user can enter commands and information into the computer 602 through one or more wire/wireless input devices, for example, a keyboard 638 and a pointing device, such as a mouse 640. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 604 through an input device interface 642 that is coupled to the system bus 608, but can be connected by other interfaces such as a parallel port, IEEE 994 serial port, a game port, a USB port, an IR interface, and so forth.

A monitor 644 or other type of display device is also connected to the system bus 608 via an interface, such as a video adaptor 646. The monitor 644 may be internal or external to the computer 602. In addition to the monitor 644, a computer typically includes other peripheral output devices, such as speakers, printers, and so forth.

The computer 602 may operate in a networked environment using logical connections via wire and/or wireless communications to one or more remote computers, such as a remote computer 648. The remote computer 648 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 650 is illustrated. The logical connections depicted include wire/wireless connectivity to a local area network (LAN) 652 and/or larger networks, for example, a wide area network (WAN) 654. Such LAN and WAN networking environments are commonplace in offices and companies, and facilitate enterprise-wide computer networks, such as intranets, all of which may connect to a global communications network, for example, the Internet.

When used in a LAN networking environment, the computer 602 is connected to the LAN 652 through a wire and/or wireless communication network interface or adaptor 656. The adaptor 656 can facilitate wire and/or wireless communications to the LAN 652, which may also include a wireless access point disposed thereon for communicating with the wireless functionality of the adaptor 656.

When used in a WAN networking environment, the computer 602 can include a modem 658, or is connected to a communications server on the WAN 654, or has other means for establishing communications over the WAN 654, such as by way of the Internet. The modem 658, which can be internal or external and a wire and/or wireless device, connects to the system bus 608 via the input device interface 642. In a networked environment, program modules depicted relative to the computer 602, or portions thereof, can be stored in the remote memory/storage device 650. It will be appreciated that the network connections shown are exemplary and other means of establishing a communications link between the computers can be used.

The computer 602 is operable to communicate with wire and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

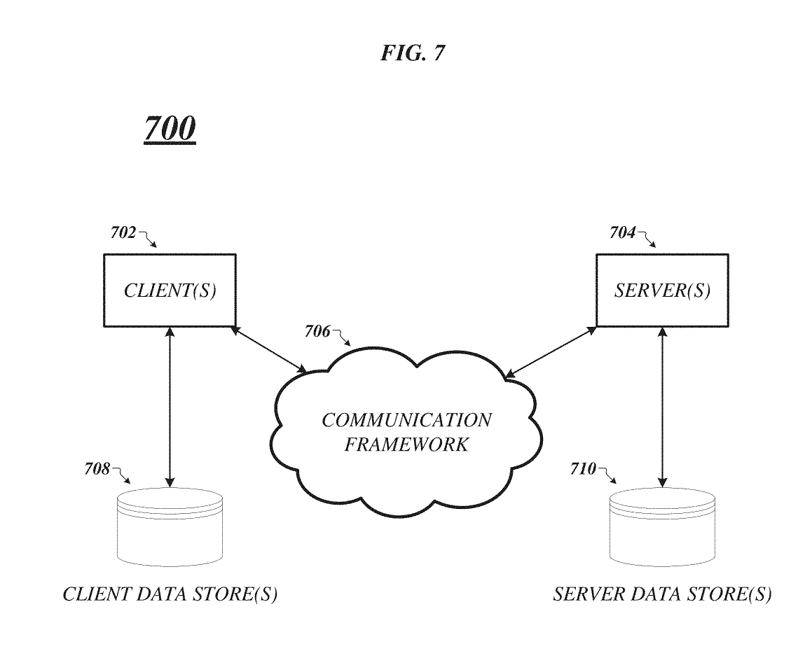

FIG. 7 illustrates a block diagram of an exemplary communications architecture 700 suitable for implementing various embodiments as previously described. The communications architecture 700 includes various common communications elements, such as a transmitter, receiver, transceiver, radio, network interface, baseband processor, antenna, amplifiers, filters, power supplies, and so forth. The embodiments, however, are not limited to implementation by the communications architecture 700.

As shown in FIG. 7, the communications architecture 700 comprises includes one or more clients 702 and servers 704. The clients 702 and the servers 704 are operatively connected to one or more respective client data stores 708 and server data stores 710 that can be employed to store information local to the respective clients 702 and servers 704, such as cookies and/or associated contextual information. In various embodiments, any one of servers 704 may implement one or more of logic flows or operations described herein, and storage medium 500 of FIG. 5 in conjunction with storage of data received from any one of clients 702 on any of server data stores 710.

The clients 702 and the servers 704 may communicate information between each other using a communication framework 706. The communications framework 706 may implement any well-known communications techniques and protocols. The communications framework 706 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 706 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1900 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 702 and the servers 704. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The following examples pertain to further embodiments, from which numerous permutations and configurations will be apparent.

Example 1 is an apparatus to perform input/output (I/O) operations, the apparatus comprising: a processor component communicatively coupled with an antenna via a first set of conductive connections; a peripheral port coupled to the processor component via a second set of conductive connections; and a peripheral port extender including one or more conductive connections of the second set of conductive connections, the peripheral port extender to reversibly transition the peripheral port between a retracted state and an extended state, a distance between the peripheral port and the antenna to increase in response to a transition from the retracted state to the extended state.

Example 2 includes the subject matter of Example 1, comprising the peripheral port communicatively coupled to the processor component.

Example 3 includes the subject matter of any of Examples 1 to 2, the peripheral port arranged to provide electrical power to the processor component via the second set of conductive connections.

Example 4 includes the subject matter of any of Examples 1 to 3, the distance between the peripheral port and the antenna to decrease when the peripheral port is transitioned from the extended state to the retracted state.

Example 5 includes the subject matter of any of Examples 1 to 4, the peripheral port extender comprising a plurality of extended states, the distance between the peripheral port and the antenna to increase a different amount when the peripheral port is transitioned from the retracted state to each of the plurality of extended states.

Example 6 includes the subject matter of any of Examples 1 to 5, the first and second sets of conductive connections comprising shielding from radio frequency (RF) interference or from RF emissions produced by the first or second set of conductive connections.

Example 7 includes the subject matter of any of Examples 1 to 6, the peripheral port to connect to a wired peripheral to communicatively couple the processor component and the wired peripheral.

Example 8 includes the subject matter of Example 7, the wired peripheral comprising one or more of a display, a keyboard, a mouse, a wireless mouse dongle, an external hard drive, a flash drive, a controller, a speaker, a power source, or a hotspot.

Example 9 includes the subject matter of any of Examples 1 to 8, the peripheral port comprising one or more of a universal serial bus (USB) port, a high-definition multimedia interface (HDMI) port, a display port (DP), or a thunderbolt port.

Example 10 includes the subject matter of any of Examples 1 to 9, at least one of the one or more conductive connections of the second set of conductive connections included in the peripheral port extender to include a cable comprising a plurality of electrically isolated conductors.

Example 11 includes the subject matter of Example 10, the cable comprising shielding from radio frequency interference (RFI) or from production of RF emission by the cable.

Example 12 includes the subject matter of any of Examples 10 to 11, the processor component to utilize the cable for differential signaling or single-ended signaling.

Example 13 includes the subject matter of any of Examples 1 to 12, the peripheral port extender comprising a retractor, the retractor to assist a transition of the peripheral port from one or more of the retracted state to the extended state and the extended state to the retracted state.

Example 14 includes the subject matter of Example 13, the retractor to store an amount of potential kinetic energy, the amount of potential kinetic energy stored by the retractor to increase when the peripheral port is transitioned from the retracted state to the extended state and decrease when the peripheral port is transitioned from the extended state to the retracted state.

Example 15 includes the subject matter of any of Examples 1 to 14, comprising a sensor to determine a state of the peripheral port.

Example 16 includes the subject matter of any of Examples 1 to 15, comprising a printed circuit board (PCB) including at least one conductive connection in the first set of conductive connections and at least one conductive connection in the second set of conductive connections.

Example 17 includes the subject matter of any of Examples 1 to 16, the peripheral port comprising shielding from radio frequency interference (RFI) or from RF emission produced by the peripheral port.

Example 18 includes the subject matter of any of Examples 1 to 17, the processor component comprising one or more of a network interface controller (NIC), a central processing unit (CPU), a broadband processor, a radio processor, a graphics processing unit (GPU), or a system on a chip (SOC).

Example 19 is a method for repositioning a peripheral port, the method comprising transitioning a peripheral port from a retracted state to an extended state with a peripheral port extender, the peripheral port coupled to a processor component via a first set of conductive connections and the peripheral port extender comprising one or more conductive connections in the first set of conductive connections, the processor component communicatively coupled with an antenna via a second set of conductive connections, and a distance between the peripheral port and the antenna to increase in response to the transition from the retracted state to the extended state.

Example 20 includes the subject matter of Example 1, comprising the peripheral port communicatively coupled to the processor component.

Example 21 includes the subject matter of any of Examples 19 to 20, the peripheral port arranged to provide electrical power to the processor component via the second set of conductive connections.

Example 22 includes the subject matter of any of Examples 19 to 21, comprising transitioning the peripheral port from the extended state to the retracted state, the distance between the peripheral port and the antenna to decrease in response to the transition from the extended state to the retracted state.

Example 23 includes the subject matter of any of Examples 19 to 22, the peripheral port extender comprising a plurality of extended states, the distance between the peripheral port and the antenna to increase a different amount when the peripheral port is transitioned from the retracted state to each of the plurality of extended states.

Example 24 includes the subject matter of any of Examples 19 to 23, the first and second sets of conductive connections comprising shielding from radio frequency interference (RFI) or from RF emissions produced by the first or second set of conductive connections.

Example 25 includes the subject matter of any of Examples 19 to 24, comprising connecting the peripheral port to a wired peripheral to communicatively couple the processor component and the wired peripheral.

Example 26 includes the subject matter of Example 25, the wired peripheral comprising one or more of a display, a keyboard, a mouse, a wireless mouse dongle, an external hard drive, a flash drive, a controller, a speaker, a power source, or a hotspot.

Example 27 includes the subject matter of any of Examples 19 to 26, the peripheral port comprising one or more of a universal serial bus (USB) port, a high-definition multimedia interface (HDMI) port, a display port (DP), or a thunderbolt port.

Example 28 includes the subject matter of any of Examples 19 to 27, at least one of the one or more conductive connections of the second set of conductive connections included in the peripheral port extender including a cable comprising a plurality of electrically isolated conductors.

Example 29 includes the subject matter of Example 28, the cable comprising shielding from radio frequency interference (RFI) or from RF emissions produced by the cable.

Example 30 includes the subject matter of any of Examples 28 to 29, the processor component utilizing the cable for differential signaling or single-ended signaling.

Example 31 includes the subject matter of any of Examples 19 to 30, the peripheral port extender comprising a retractor, the retractor for assisting a transition of the peripheral port from one or more of the retracted state to the extended state and the extended state to the retracted state.

Example 32 includes the subject matter of Example 31, the retractor storing an amount of potential kinetic energy, the amount of potential kinetic energy stored by the retractor to increase when the peripheral port is transitioned from the retracted state to the extended state and decrease when the peripheral port is transitioned from the extended state to the retracted state.

Example 33 includes the subject matter of any of Examples 19 to 32, comprising a sensor for determining a state of the peripheral port.

Example 34 includes the subject matter of any of Examples 19 to 33, comprising a printed circuit board (PCB) including at least one conductive connection in the first set of conductive connections and at least one conductive connection in the second set of conductive connections.

Example 35 includes the subject matter of any of Examples 19 to 34, the peripheral port comprising shielding from radio frequency interference (RFI) or from RF emissions produced by the peripheral port.

Example 36 includes the subject matter of any of Examples 19 to 35, the processor component comprising one or more of a network interface controller (NIC), a central processing unit (CPU), a broadband processor, a radio processor, a graphics processing unit (GPU), or a system on a chip (SOC).

Example 37 is a system to perform input/output (I/O) operations, the system comprising: a processor component communicatively coupled with an antenna via a first set of conductive connections; a peripheral port coupled to the processor component via a second set of conductive connections, the peripheral port to connect to a wired peripheral to couple the processor component and the wired peripheral; and a peripheral port extender including one or more conductive connections of the second set of conductive connections, the peripheral port extender to reversibly transition the peripheral port between a retracted state and an extended state, a distance between the peripheral port and the antenna to increase in response to a transition from the retracted state to the extended state.

Example 38 includes the subject matter of Example 37, comprising the peripheral port communicatively coupled to the processor component.

Example 39 includes the subject matter of any of Examples 37 to 38, the peripheral port arranged to provide electrical power to the processor component via the second set of conductive connections.

Example 40 includes the subject matter of any of Examples 37 to 39, the distance between the peripheral port and the antenna to decrease when the peripheral port is transitioned from the extended state to the retracted state.

Example 41 includes the subject matter of any of Examples 37 to 40, the peripheral port extender comprising a plurality of extended states, the distance between the peripheral port and the antenna to increase a different amount when the peripheral port is transitioned from the retracted state to each of the plurality of extended states.

Example 42 includes the subject matter of any of Examples 37 to 41, the first and second sets of conductive connections comprising shielding from radio frequency interference (RFI) or RF emissions produced by the first or second set of conductive connections.

Example 43 includes the subject matter of any of Examples 37 to 42, the wired peripheral comprising one or more of a display, a keyboard, a mouse, a wireless mouse dongle, an external hard drive, a flash drive, a controller, a speaker, a power source, or a hotspot.

Example 44 includes the subject matter of any of Examples 37 to 43, the peripheral port comprising one or more of a universal serial bus (USB) port, a high-definition multimedia interface (HDMI) port, a display port (DP), or a thunderbolt port.

Example 45 includes the subject matter of any of Examples 37 to 44, at least one of the one or more conductive connections of the second set of conductive connections included in the peripheral port extender to include a cable comprising a plurality of electrically isolated conductors.

Example 46 includes the subject matter of Example 45, the cable comprising shielding from radio frequency interference (RFI) or from RF emissions produced by the cable.

Example 47 includes the subject matter of any of Examples 45 to 46, the processor component to utilize the cable for differential signaling or single-ended signaling.

Example 48 includes the subject matter of any of Examples 37 to 47, the peripheral port extender comprising a retractor, the retractor to assist a transition of the peripheral port from one or more of the retracted state to the extended state and the extended state to the retracted state.

Example 49 includes the subject matter of Example 48, the retractor to store an amount of potential kinetic energy, the amount of potential kinetic energy stored by the retractor to increase when the peripheral port is transitioned from the retracted state to the extended state and decrease when the peripheral port is transitioned from the extended state to the retracted state.

Example 50 includes the subject matter of any of Examples 37 to 49, comprising a sensor to determine a state of the peripheral port.

Example 51 includes the subject matter of any of Examples 37 to 50, comprising a printed circuit board (PCB) including at least one conductive connection in the first set of conductive connections and at least one conductive connection in the second set of conductive connections.

Example 52 includes the subject matter of any of Examples 37 to 51, the peripheral port comprising shielding from radio frequency interference (RFI) or from RF emissions produced by the peripheral port.

Example 53 includes the subject matter of any of Examples 37 to 52, the processor component comprising one or more of a network interface controller (NIC), a central processing unit (CPU), a broadband processor, a radio processor, a graphics processing unit (GPU), or a system on a chip (SOC).

Example 54 is an apparatus for repositioning a peripheral port, the apparatus comprising means for transitioning a peripheral port from a retracted state to an extended state, the peripheral port coupled to a processing means via a first set of conductive connections and the means for transitioning the peripheral port comprising one or more conductive connections in the first set of conductive connections, the processing means communicatively coupled with an antenna via a second set of conductive connections, and a distance between the peripheral port and the antenna to increase in response to the transition from the retracted state to the extended state.

Example 55 includes the subject matter of Example 54, comprising the peripheral port communicatively coupled to the processing means.

Example 56 includes the subject matter of any of Examples 54 to 55, the peripheral port arranged to provide electrical power to the processing means via the second set of conductive connections.

Example 57 includes the subject matter of any of Examples 54 to 56, comprising transitioning the peripheral port from the extended state to the retracted state, the distance between the peripheral port and the antenna to decrease in response to the transition from the extended state to the retracted state.

Example 58 includes the subject matter of any of Examples 54 to 57, the means for transitioning the peripheral port comprising a plurality of extended states, the distance between the peripheral port and the antenna to increase a different amount when the peripheral port is transitioned from the retracted state to each of the plurality of extended states.

Example 59 includes the subject matter of any of Examples 54 to 58, the first and second sets of conductive connections comprising shielding from radio frequency interference (RFI) or from RF emissions produced by the first or second sets of conductive connections.

Example 60 includes the subject matter of any of Examples 54 to 59, comprising connecting the peripheral port to a wired peripheral to communicatively couple the processing means and the wired peripheral.

Example 61 includes the subject matter of Example 60, the wired peripheral comprising one or more of a display, a keyboard, a mouse, a wireless mouse dongle, an external hard drive, a flash drive, a controller, a speaker, a power source, or a hotspot.

Example 62 includes the subject matter of any of Examples 54 to 61, the peripheral port comprising one or more of a universal serial bus (USB) port, a high-definition multimedia interface (HDMI) port, a display port (DP), or a thunderbolt port.

Example 63 includes the subject matter of any of Examples 54 to 62, at least one of the one or more conductive connections of the second set of conductive connections included in the means for transitioning the peripheral port including a cable comprising a plurality of electrically isolated conductors.

Example 64 includes the subject matter of Example 63, the cable comprising shielding from radio frequency interference (RFI) or from RF emissions produced by the cable.

Example 65 includes the subject matter of any of Examples 63 to 64, the processing means utilizing the cable for differential signaling or single-ended signaling.

Example 66 includes the subject matter of any of Examples 54 to 65, the means for transitioning the peripheral port comprising a retractor means, the retractor means for assisting a transition of the peripheral port from one or more of the retracted state to the extended state and the extended state to the retracted state.

Example 67 includes the subject matter of Example 66, the retractor means storing an amount of potential kinetic energy, the amount of potential kinetic energy stored by the retractor means to increase when the peripheral port is transitioned from the retracted state to the extended state and decrease when the peripheral port is transitioned from the extended state to the retracted state.

Example 68 includes the subject matter of any of Examples 54 to 67, comprising a sensor for determining a state of the peripheral port.

Example 69 includes the subject matter of any of Examples 54 to 68, comprising a printed circuit board (PCB) including at least one conductive connection in the first set of conductive connections and at least one conductive connection in the second set of conductive connections.

Example 70 includes the subject matter of any of Examples 54 to 69, the peripheral port comprising shielding from radio frequency interference (RFI) or RF emissions produced by the peripheral port.

Example 71 includes the subject matter of any of Examples 54 to 70, the processing means comprising one or more of a network interface controller (NIC), a central processing unit (CPU), a broadband processor, a radio processor, a graphics processing unit (GPU), or a system on a chip (SOC).

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

1. An apparatus, comprising:
a processor component communicatively coupled with an antenna via a first set of conductive connections;
a peripheral port coupled to the processor component via a second set of conductive connections; and
a peripheral port extender including one or more conductive connections of the second set of conductive connections, the peripheral port extender to reversibly transition the peripheral port between a retracted state and an extended state, a distance between the peripheral port and the antenna to increase in response to a transition from the retracted state to the extended state.

2. The apparatus of claim 1, comprising the peripheral port communicatively coupled to the processor component.

3. The apparatus of claim 1, the peripheral port arranged to provide electrical power to the processor component via the second set of conductive connections.

4. The apparatus of claim 1, the distance between the peripheral port and the antenna to decrease when the peripheral port is transitioned from the extended state to the retracted state.

5. The apparatus of claim 1, the peripheral port extender comprising a plurality of extended states, the distance between the peripheral port and the antenna to increase a different amount when the peripheral port is transitioned from the retracted state to each of the plurality of extended states.

6. The apparatus of claim 1, the first or second set of conductive connections comprising shielding from radio frequency (RF) interference or from RF emissions produced by the first or second set of conductive connections.

7. The apparatus of claim 1, the peripheral port to connect to a wired peripheral to communicatively couple the processor component and the wired peripheral.

8. The apparatus of claim 7, the wired peripheral comprising one or more of a display, a keyboard, a mouse, a wireless mouse dongle, an external hard drive, a flash drive, a controller, a speaker, a power source, or a hotspot.

9. The apparatus of claim 1, the peripheral port comprising one or more of a universal serial bus (USB) port, a high-definition multimedia interface (HDMI) port, a display port (DP), or a thunderbolt port.

10. The apparatus of claim 1, at least one of the one or more conductive connections of the second set of conductive connections and included in the peripheral port extender to include a cable comprising a plurality of electrically isolated conductors.

11. The apparatus of claim 10, the cable comprising shielding from radio frequency (RF) interference or from RF emissions produced by the cable.

12. The apparatus of claim 10, the processor component to utilize the cable for differential signaling or single ended signaling.

13. The apparatus of claim 1, the peripheral port extender comprising a retractor, the retractor to assist a transition of the peripheral port from one or more of the retracted state to the extended state and the extended state to the retracted state.

14. The apparatus of claim 13, the retractor to store an amount of potential kinetic energy, the amount of potential kinetic energy stored by the retractor to increase when the peripheral port is transitioned from the retracted state to the extended state and decrease when the peripheral port is transitioned from the extended state to the retracted state.

15. The apparatus of claim 1, comprising a sensor to determine a state of the peripheral port extender.

16. The apparatus of claim 1, comprising a printed circuit board (PCB) including at least one conductive connection in the first set of conductive connections and at least one conductive connection in the second set of conductive connections.

17. The apparatus of claim 1, the peripheral port comprising shielding from radio frequency (RF) interference or from RF emissions produced by the peripheral port.

18. The apparatus of claim 1, the processor component comprising one or more of a network interface controller (NIC), a central processing unit (CPU), a broadband processor, a radio processor, a graphics processing unit (GPU), or a system on a chip (SOC).

19. A method for repositioning a peripheral port, the method comprising transitioning a peripheral port from a retracted state to an extended state with a peripheral port extender, the peripheral port coupled to a processor component via a first set of conductive connections and the peripheral port extender comprising one or more conductive connections in the first set of conductive connections, the processor component communicatively coupled with an antenna via a second set of conductive connections, and a distance between the peripheral port and the antenna to increase in response to the transition from the retracted state to the extended state.

20. The method of claim 19, comprising the peripheral port communicatively coupled to the processor component.

21. The method of claim 19, the peripheral port arranged to provide electrical power to the processor component via the second set of conductive connections.

22. The method of claim 19, comprising transitioning the peripheral port from the extended state to the retracted state, the distance between the peripheral port and the antenna to decrease in response to the transition from the extended state to the retracted state.

23. The method of claim 19, the peripheral port extender comprising a plurality of extended states, the distance between the peripheral port and the antenna to increase a different amount when the peripheral port is transitioned from the retracted state to each of the plurality of extended states.

24. The method of claim 19, the first or second set of conductive connections comprising shielding from radio frequency (RF) interference or from RF emission by the first or second set of conductive connections.

25. The method of claim 19, comprising connecting the peripheral port to a wired peripheral to communicatively couple the processor component and the wired peripheral.
